(19) United States
(12) Patent Application Publication
(10) Pub. No.: US 2011/0282744 A1
(43) Pub. Date: Nov. 17, 2011

(54) NETWORK-BASED SYSTEM OF RELAYING CONTENTS FOR ADVERTISEMENT PRODUCTS AND ONLINE SHOPPING THE ADVERTISEMENT PRODUCTS AND METHOD THEREOF

(76) Inventor: Seungmu Yang, Seoul (KR)

(21) Appl. No.: 13/145,518

(22) PCT Filed: Jan. 30, 2009
(86) PCT No.: PCT/KR2009/000454

§ 371 Date: Jul. 20, 2011

(51) Int. Cl. G06Q 30/00

(52) U.S. Cl. 705/14.58; 705/14.49

(57) ABSTRACT

A network-based system for relaying contents for advertisement products includes a plurality of display devices for advertisement configured to display the advertisement products and represent identifiers which distinguish the advertisement products, respectively, and one or more mobile terminals for requesting for the relay of a content for an advertisement product of interest via a network by using an identifier of the advertisement product. A management server management server recognizes which content is for the advertisement product of interest based on the identifier from the mobile terminal, and relays the recognized content to the mobile terminal via the network to thereby interwork with the mobile terminal. The mobile terminal reproduces and searches for the content for the advertisement product relayed from the management server, and performs purchase of the advertisement product.

### TECHNICAL FIELD

The present invention relates to a network-based system of relaying contents for advertisement products, and more particularly, to a network-based system, which relays contents for advertisement products being presented in an display device for advertisement to a mobile terminal, reproduces the contents for the advertisement products to search for an advertisement product of interest and performs an online shopping of the advertisement product in the mobile terminal, and a method thereof.

### BACKGROUND ART

Advertisement is frequently performed through broadcasting media such as TV or print media such as newspapers. In an advertisement scheme using the broadcasting medium or print medium, the advertisement is performed for a given period of time or through a designated space.

On the other hand, other advertisement media include electronic signboards for advertisement installed indoors/outdoors of buildings and small-sized advertisement display panels, small-sized advertisement monitors, and the like installed on shops on streets and public transportation means such as subways, buses, etc.

Among them, the electronic signboard displays advertisement images made for a specific company or for improving products of the company or the image of the company through a large-sized screen thereof. The advertise scheme using the electronic signboard has a merit that image contents can be advertised without any limit to advertising time or the size of space. Due to this merit, electronic signboards are installed throughout indoors/outdoors of buildings, a street, etc. that people can easily see.

The advertisement using the electronic signboard is a one-way advertisement for providing advertisement contents to the masses one-sidedly, and thus, two-way communication with the potential masses that are viewing the advertisement is impossible. TV broadcasting, which is a typical one-way medium, is greatly reinforced with the function of storing a viewer-desired broadcast program and reproducing it if required by digitalization and the function of two-way communication with viewers, including the uploading of viewers' opinions on broadcast programs. However, no such function is implemented in the electronic signboards. Thus, there has been no interworking between viewers and the electronic signboards at all, such as the reproducing of advertisement contents viewed through the electronic signboard or the acquisition of information about an advertised product accompanying the advertisement contents.

Consequently, if there is a scheme to link contents for advertisement products being presented in an electronic signboard installed indoors/outdoors to a mobile terminal so that the user of the mobile terminal can reproduce and search for the advertisement products and immediately perform electronic commerce of the searched advertisement product, the creation of new added values can be expected.

### DISCLOSURE OF INVENTION

### Technical Problem

It is, therefore, an object of the present invention to provide a network-based system, which relays contents for advertisement products being presented in a display device for advertisement to a mobile terminal, reproduces the contents for the advertisement products to search for an advertisement product of interest, and performs an online shopping of the searched advertisement product in the mobile terminal, and a method thereof.

Another object of the present invention is to provide a network-based system, for directly accessing an online shopping mall selling an advertisement product being presented in a display device for advertisement and perform an online shopping of the advertisement product, and a method thereof.

### Technical Solution

In accordance with one aspect of the present, there is provided a network-based system for relaying contents for advertisement products, comprising: a plurality of display devices for advertisement, each of which is configured to present advertisement products and represent identifiers distinguishing each display device and each advertisement product; one or more mobile terminals for requesting for the relay of a content for an advertisement product of interest or contents including the content for the advertisement product of interest being displayed in any of the display devices via a network by using an identifier; and a management server for managing information of the identifiers and the contents for the advertisement products, recognizing which display device is presenting the advertisement product of interest or which content is for the advertisement product of interest based on the identifier from the mobile terminal, retrieving the content for the advertisement product of interest or the contents including the content for the advertisement product of interest, and relaying the retrieved content or the retrieved contents to the mobile terminal via the network to thereby interwork with the mobile terminal, wherein the mobile terminal reproduces and searches for the content or the contents relayed from the management server, and performs electronic commerce of the advertisement product of the searched content.

In accordance with another aspect of the present invention, there is provided a method of searching for advertisement products in a network-based system comprising a plurality of display devices for advertisement, one or more mobile terminal, and a management server, comprising the steps of: representing an identifier while displaying each of the advertisement products in each of the display devices, each of the display devices and each of the advertisement products being distinguished by the corresponding identifier; making, at the mobile terminal, a request for the relay of a content for an advertisement product of interest or contents including the content for the advertisement product of interest being displayed in any of the display devices by using the represented identifier via a network; recognizing, at the management server, which display device is presenting the advertisement product of interest or which content is for the advertisement product of interest based on the identifier from the mobile terminal; relaying, at the management server, the contents for the advertisement products presented in the recognized display device or the recognized content for the advertisement product of interest and product-related information to the mobile terminal via the network; providing, at the management server, the mobile terminal with a GUI (graphic user interface) program for creating a menu screen for searching for the contents and the product-related information; and searching for, at the mobile terminal, an advertisement product accompanied by the contents and the product-related information through the menu screen created by the GUI program.

In accordance with further another aspect of the present invention, there is provided a method of performing electronic commerce of advertisement products in a network-based system including a plurality of display devices for advertisement, one or more mobile terminals, a management server and online shopping malls, comprising the steps of: displaying each of the advertisement products in the display devices while representing an identifier thereof, each of the advertisement products being distinguished by the corresponding identifier; making, at the mobile terminal, a request for access to an online shopping mall selling anyone of interest among the advertisement products via a network by using the represented identifier; recognizing, at the management server, the online shopping mall selling the product of interest based on the represented identifier transmitted from the mobile terminal and forwarding the shopping mall access request of the mobile terminal to the recognized online shopping mall so as to establish a link between the mobile terminal and the recognized online shopping mall; and performing, at the mobile terminal, a purchase of the advertisement product of interest from the linked online shopping mall.

### Advantageous Effects

According to the present invention, by promptly relaying content for the advertisement product, information on the advertisement product and online shopping information of the advertisement product to a mobile terminal, a user of the mobile terminal can review a variety of additional information on the advertisement product, and, if required, can make a purchase request for the advertisement product immediately. Therefore, there is a merit that a potential viewer of the advertisement products provided by the display device may benefit a variety of services.

Furthermore, supplementary services may be actively offered by inducing collaboration between users of mobile terminals during electronic commerce. Moreover, an advertiser using the display device may enjoy the merit of increase in sales because the advertisement of a product leads to purchases.

### BRIEF DESCRIPTION OF DRAWINGS

FIG. 1 illustrates a block diagram of a network-based content relay system in accordance with one embodiment of the present invention;

FIG. 2 provides a detailed block diagram of the display device as shown in FIG. 1;

FIG. 3 shows a detailed block diagram of the mobile terminal as shown in FIG. 1;

FIG. 4 presents a view illustratively showing the configuration of a menu screen created in the mobile terminal;

FIG. 5 illustrates a flow chart for explaining a procedure of performing content relay in accordance with one embodiment of the present invention;

FIG. 6 offers a flow chart for explaining a procedure of performing electronic commerce in accordance with one embodiment of the present invention; and

FIG. 7 illustrates a flow chart for explaining a procedure of requesting for an access to an online shopping mall in accordance with another embodiment of the present invention.

### BEST MODE FOR CARRYING OUT THE INVENTION

Hereinafter, embodiments of the present invention will be described in detail with reference to the accompanying drawings.

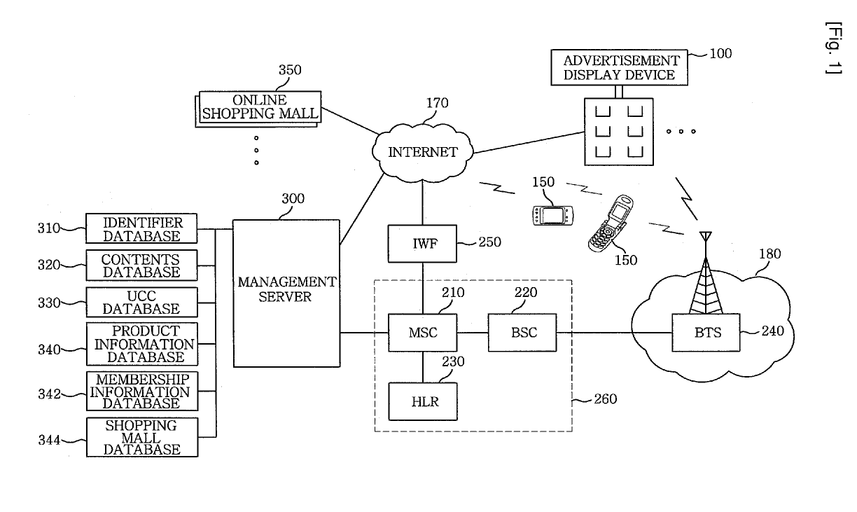

FIG. 1 illustrates a block diagram of a network-based content relay system in accordance with one embodiment of the present invention.

As shown in FIG. 1, the network-based content relay system of the present invention includes a plurality of display devices for advertisement 100, one or more mobile terminals 150, a management server 300, and a plurality of online shopping malls 350.

First, the present invention will be described briefly. Each of the display devices 100 presents or displays a plurality of advertisement products to many unspecified people. Here, the advertisement products accompany contents of digital videos, photographs, and texts with the advertised products. The display device 100 may include LED-type advertisement electronic signboards installed indoors/outdoors of buildings in different zones, CRT, LCD and PDP-type advertisement monitors installed at a bus terminal or the like, and small-sized advertisement panels installed at subways and bus stops for representing destination guidance and having advertising posters, pictures, images and the like, all of which are electronically operated.

The mobile terminal 150 allows the user who is interested in an advertisement product presented by the display device 100 to request the management server 300 for the relay of contents for the advertisement product of interest through a network 170 or 180. Such a mobile terminal 150 may includes cellular phones, PCS phones, and smart phones, which are capable of voice calls via the network 180 and 170 and have a wireless communication capability. The terminal may further comprises notebook PC, Ultra-Mobile PCs, PDAs (personal data assistants), and the like which are equipped with a wireless application protocol (WAP). The network 170 includes the Internet, a wireless local area network (WLAN), a wireless broadband (WiBro) network, and an NFC (near field communication), and the network 180 includes CDMA, GSM, and WCDMA networks.

The management server 300 communicates with the mobile terminal 150 via the networks 170 and 180 to relay the contents of the advertisement products to the mobile terminal in response to the content relay request. The mobile terminal 150 then performs to reproduce and search for the contents of the advertisement products relayed from the management server 300, and, if necessary, performs electronic commerce for making a purchase request for the searched advertisement product through an online shopping mall 350.

According to the present invention, the display device 100 operates so as to represent identifiers while presenting the advertisement products. The identifiers include an identifier identifying each of the display devices 100 and an identifier identifying each of the advertisement products. Each of the identifiers may be represented for a preset period between consecutive advertisement products, or represented in a captioned form during the display of advertisement products. Alternatively, for example, for a small-sized advertisement panel, the identifier of the advertisement product may be represented through an identifier label attached to the periphery of the panel.

Further, according to the present invention, the identifier includes letters (or codes), or telephone numbers for distinguishing the display devices and the advertisement products from one another. In case where the identifier is defined by letters, for example, the name of the region where a display device for advertisement is installed, such as ‘seoulatation1’ or ‘chungmooro2’ may be used as the identifier for discriminating each display device. Further, the name of the advertisement product, e.g., a car or a computer, presented by the display device may be used as the identifier such as ‘car-seoulatation1’ or ‘computer-seoulatation1’ for discriminating each advertisement product. In this regard, the numbers ‘1’ and ‘2’ may indicate the first and second advertisement display devices placed in the corresponding zones, respectively.

In case where the identifier is defined by codes, codes, e.g., C01, C02, . . . may be used as the identifiers for discriminating the respective display devices. Further, codes, e.g., A01C1, A02C1, . . . , or B01C2, B02C2, . . . may be utilized as the identifiers for discriminating the respective advertisement products presented by the corresponding display device.

In case where the identifier is defined by telephone number, telephone numbers, e.g., 010-123-4567, 010-123-5678, or the like usable in a mobile communication system, may be used as the identifier for discriminating each of the advertisement display devices or each of the advertisement products.

When such an identifier is represented on the display device, e.g., a guidance message saying “enter the identifier ‘seoulstation1’ or enter the identifier ‘010-123-4567’ if it is desired to search for advertisement products of interest” may be represented along with the advertisement product.

Referring back to FIG. 1, the mobile terminal 150 demands the content relay request through the network 170 or 180 by using the identifier represented in the display device 100. The identifier indicative of the content relay request is sent to the management server 300 via the network 170 and 180.

The management server 300 includes an identifier database (DB) 310, a content DB 320, a product information DB 340, a user created contents (UCC) DB 330, and a membership information DB 340.

The identifier DB 310 stores identifiers corresponding to the display devices and location information where the display devices are installed. The content DB 320 has a plurality of storage locations storing therein the contents for the advertisement products corresponding to the identifiers, the storage locations being designated by the corresponding identifiers, respectively. The subject matter of the respective contents stored in the contents DB 320 may be identical to that of the advertisement products presented in the display device 100, or may have more detailed video, pictures, and texts edited or added therein, differently from that of presented in the display device.

The product information DB 330 stores detailed information related to the advertisement products, the UCC DB 340 stores UCCs made by individuals for each advertisement product. The membership information DB 342 stores subscriber information of the mobile terminals 150 registered in the system of the present invention if the present system is operated on a membership basis.

The management server 300 is configured to communicate with each display device 100 via the network 170 and 180. For example, when advertisement products are updated or a request for new advertisement products is made to any one of the display devices 100, contents for new or updated advertisement products can be remotely provided to the corresponding display device 100 via the network 170 or 180, to thereby update the contents for the existing advertisement products presented in the display device 100. At this time, sequence control signals about the order and number of times of presenting advertisement products in the display device 100 can also be provided together.

In addition, the management server 300 is configured to communicate with the mobile terminal 150 via the network 170 and 180. When the management server 100 receives the identifier of the content relay request from the mobile terminal 150, the management server 300 recognizes what storage location in the content DB 320 is designated by the identifier, retrieves the contents stored in the storage location designated by the identifier from the contents DB 320, and relays the retrieved contents to the mobile terminal 150 via the network 170 and 180. When the contents are relayed to the mobile terminal 150, a GUI (graphic user interface) program for configuring a menu screen on the mobile terminal 150 is selectively transmitted to the mobile terminal 150 so that the reproducing and search of the advertisement products are performed through the menu screen. Also, if there is a purchase request for a searched product from the mobile terminal 150, the management server 300 interconnects between the online shopping mall 350 selling the searched product and the mobile terminal 150 to enable online shopping.

Followings are examples of the procedure in which the mobile terminal 150 requests the management server 300 for the relay of the contents using the identifier.

The first example is to use the identifier of the letter or code. First of all, the mobile terminal 150 makes a connection to the network 170 using a WAP browser and then an entry of the identifier of the letter or code in an address bar on the WAP browser so that it requests for the content relay. In this example, the entered identifier is then automatically converted into a domain name to thereby establish a connection to a server or a computer having the domain name. Such conversion can be achieved by NLIA (Native Language Internet Address) technology in which the letter or code is converted into a domain name and in turn an IP address. A detailed description of the NLIA is disclosed in US 2008/0294796, which is incorporated herein by reference in its entirety.

To do it, in this example, the management server 300 has a domain name, e.g., ‘adver.com’ and a storage location in the content DB 320 has a file name or host name, e.g., ‘seoulstation1’ or ‘car-seoulstation1’ which corresponds to a lower directory in the domain name. When the identifier of ‘seoulstation1’ or ‘car-seoulstation1’ enters the address bar on the WAP browser in the mobile terminal 150, the identifier may be automatically converted into ‘www.adver.com/seoulstation1’ or ‘www.adver.com/car-seoulstation1’. Here, an upper directory ‘adver’ indicates the domain name assigned to the management server 300, and a lower directory ‘seoulstation1’ or ‘car-seoulstation1’ indicates file name or host name assigned to a corresponding storage location in the content DB 320. Accordingly, the management server 300 can recognize which display device or which contents corresponds to the identifier.

The second example is to use the identifier of the telephone number represented in the display device 100. To do it, the telephone numbers corresponding to the identifiers are assigned to the storage locations, respectively, and calls of these telephone numbers are configured to call-forward to the management server 300. Dialing a telephone number, e.g., ‘010-123-4567’ in the mobile terminal 100 is to request for the content relay. A call of the telephone number is sent to the network 180 and is call-forwarded to the management server 300. Then, the management server 300 is informed from the mobile communication system 260 (see, FIG. 1) of the call-forwarded telephone number. Therefore, the management server 300 recognizes which display device or which content corresponds to the identifier.

The third example is to use position information of the mobile terminal 150 managed in the network 180. In this example, the user of the mobile terminals 150 should be a member in the system of the present invention.

If the user of the mobile terminal 150 desires to request for the relay of content for the advertisement products of interest, the mobile terminal 150 transmits an access request to the management server 300 through the network 180. A specific program downloaded in advance from the management server 300 makes enable such access request.

Subsequently, location information of the mobile terminal 150 is managed by the mobile communication system 260, in particular, a home location register (HLR) 230 and is provided to the management server 300. The management server 300 retrieves one or more display devices located close to mobile terminal 150 based on the location information of the mobile terminal 150 from the identifier DB 310 and then provides the mobile terminal 150 with identifiers of the retrieved display devices. Among the identifiers received from the management server 300, the mobile terminal 150 selects the same identifier as that of the display device located close to mobile terminal 150 or advertising an advertisement product of interest and informs the management server 300 of the selected identifier as a content relay request. By doing so, the management server 300 recognize which display device corresponds to the selected identifier.

Meanwhile, a base transceiver station (BTS) 240, which is composed of a radio transceiver, establishes a voice call and transmits/receives packet data via a radio link with the mobile terminal 150 within a radio access network (RAN).

The mobile communication system 260 includes a mobile switching center (MSC) 210, a base station controller (BSC) 220, and the HLR 230. The BSC 220 manages a plurality of BTSs 240 and is responsible for radio channel setup, frequency hopping, and handover process. The MSC 210 is responsible for mobility management, location registration/management, authentication, handover, and roaming of the mobile terminal 150. Also, the MSC 210 establishes a channel for data transmission/reception between the management server 30 and the mobile terminal 150 in response to the content relay request using the identifier of the telephone number from the mobile terminal 150. The HLR 230 manages the position information of the mobile terminal 150 that is registered as a member in the present system, as well as subscriber status, statistics and a variety of service-related information. IWF (inter-working function) 250 is arranged between the MSC 210 and the network 170 to transform signals from the MSC into packet data for the network 170 or vice versa.

The online shopping mall 350 includes an online shopping mall server selling a product advertised by each display device 100 or an existing typical online shopping mall server.

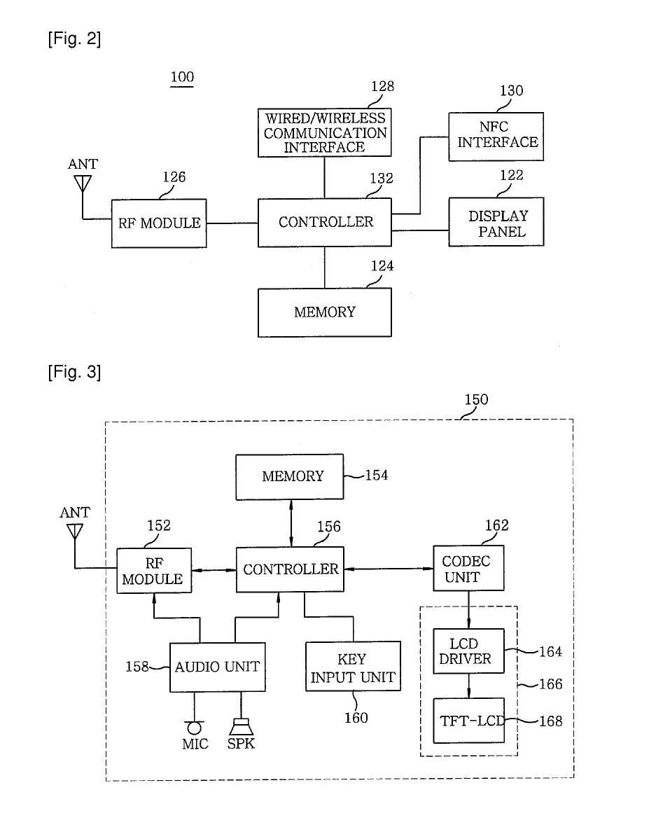

Referring now to FIG. 2, there is illustrated a detailed block diagram of a display device for advertisement. The display device 100 includes a display panel 122 for presenting the advertisement products, a memory 124 for storing contents for the advertisement products, and a controller 132 for the sequence control of the order, and number of times of presenting the advertisement products. In addition, the display device 100 further includes a radio frequency (RF) module 126 for communication with the management server 300 and the mobile terminal 150 via the networks 170 and 180, a wired/wireless communication interface 128, and an NFC (near field communication) interface 130.

FIG. 3 shows a detailed block diagram of the mobile terminal 150.

The mobile terminal 150 includes an RF module 152, a memory 154, a controller 156, a codec unit 162, an audio unit 158, a key input unit 160, and a display unit 166.

The controller 156 controls the overall operation of the mobile terminal 150 for performing a wireless communication and a variety of multimedia functions.

When the mobile terminal 150 operates in conjunction with the management server 300 via the network 170 or 180, the RF module 152 converts the content relay request into an RF signal and wirelessly transmits it to the management server 300 via the network 170 or 180, and receives multimedia data including the contents for the advertisement products relayed from the management server 300 and converts it into a baseband frequency signal useful in the mobile terminal 150. In addition, the RF module 152, when the mobile terminal 150 is linked with the shopping mall 350 via the network 170 or 180, converts an electronic commerce-related signal transmitted/received between the mobile terminal 150 and the shopping mall 350 into an RF signal/baseband signal so that the mobile terminal 150 enables electronic commerce of the advertisement product.

The codec unit 162 decompresses and decodes the multimedia data including contents for the advertisement products under control of the controller 156. The memory 154 stores data being processed when the controller 156 executes the overall operation of the mobile terminal 150. Specifically, the memory 154 stores the contents for the advertisement products and GUI program provided from the management server 300. The key input unit 160 generates key data when the user of the mobile terminal 150 presses any key, and this key data is converted into an RF signal through the RF module 152 and wirelessly transmitted via the network 170 or 180.

The audio unit 158 demodulates an audio signal included in the contents or UCCs relating to the contents and sends the demodulated audio signal to a speaker SPK under control of the controller 156. That is, the audio unit 158 allows a user who is watching the images of the contents or the UCCs reproduced in the mobile terminal 150 to listen to image-related audio.

The display unit 166 is constituted by a TFT-LCD 168 and an LCD driver 166 for driving the TFT-LCD 168 to display the images provided from the codec unit 162 on the TFT-LCD 168, and the key data generated by the key input unit 160 and various operation control signals of the controller 156. Also, when the GUI program is fetched from the memory 154 and then executed by the controller 156, the display unit 166 displays a menu screen for reproducing, searching, and online shopping the advertisement products.

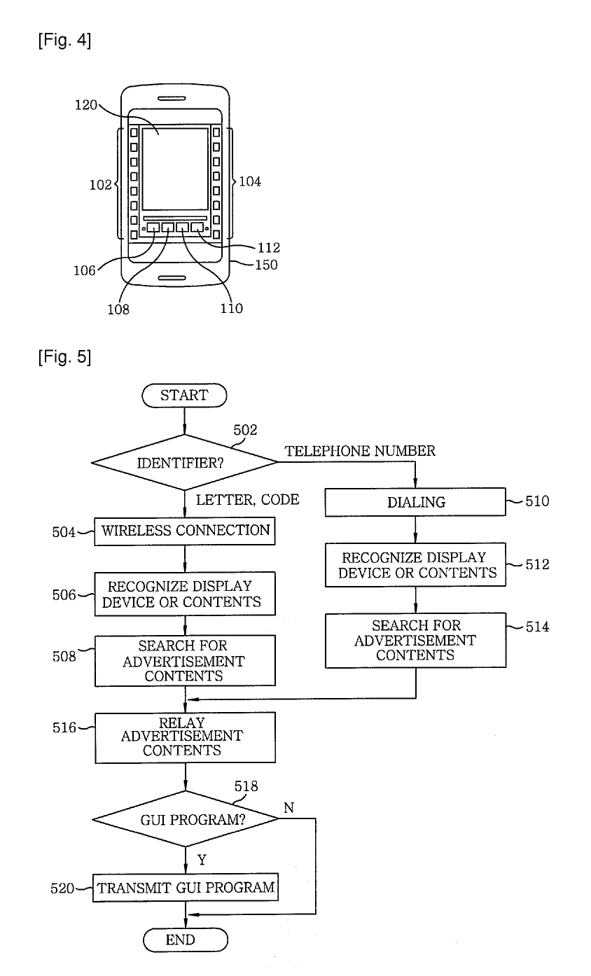

FIG. 4 illustratively shows an example of the menu screen established by the GUI program provided to the mobile terminal 150 from the management server 300.

As shown, the menu screen established on the display unit 166 of the mobile terminal 150 is implemented to include a plurality of menu keys, such as a plurality of contents search keys 102 for searching the contents in upper, lower, left, and right side regions with respect to the center region 120 of the display unit 166, a UCC search key 104 for searching for a UCC relating to the contents, a product information search key 106 for searching the advertisement products, and a shopping mall access key 108 for accessing a shopping mall selling the advertisement products.

Further, the menu screen may be implemented in various manners as follows by using the GUI program. For example, a specific button (e.g., ‘advertisement product select button (not shown)’) may be implemented on the mobile terminal 150 by the GUI program. And, by pressing the advertisement product select button on the mobile terminal 150, the video of an advertisement product being currently presented on the display device 100, and detailed information, UCCs and shopping information of the advertisement product may be reproduced in a synchronized fashion. Here, the shopping information may include product promotions having product descriptions in narration/voice-over given by shopping hosts, or additional contents for advertisement products required for shopping. Further, the detailed information of the product may include information such as its color, price, size, features (date of manufacture, manufacturer, etc.) and so forth.

As another example, a specific button (e.g., ‘slide image select button (not shown)’) may be implemented on the mobile terminal 150 by the GUI program. And, by pressing the slide image select button on the mobile terminal 150, the slides of advertisement products may be arranged in a scroll manner in the mobile terminal 150. At this time, by allotting a slide ID to each slide screen and selecting a slide ID of interest in the mobile terminal 150, advertisement products corresponding to the slide ID may be reproduced in the mobile terminal 150.

As a further example, a specific button (e.g., ‘slide review button (not shown)) may be implemented on the mobile terminal 150 by the GUI program. And, by pressing the slide review button on the mobile terminal 150, a slide screen of each advertisement product may be automatically turned over page by page as if photographs taken by a digital camera were reviewed. At this time, by selecting a slide of interest in the mobile terminal 150, content for the slide may be reproduced in the mobile terminal 150.

Accordingly, depending on the selection of certain key on the menu screen established by the GUI program, detailed information of advertisement products, UCCs associated with the advertisement product, shopping information of the product, and so forth may be reproduced and searched in the mobile terminal 150. In addition, purchase of the advertisement product selected in the mobile terminal 150 may be performed.

In the above, it has been described that one embodiment of the present invention has a scheme in which the mobile terminal 150 requests the management server 300 for the relay of the contents of the advertisement products of interest by using the identifier.

Alternatively, another embodiment of the present invention may be implemented in a manner that the mobile terminal 150 directly makes a request for access to an online shopping mall 350 selling an advertisement product of interest without requesting content for the advertisement product from the management server 300. Another embodiment of the present invention is substantially identical to the one embodiment of the present invention except for the following aspects.

In another embodiment of the present invention, the display device 100 represents an identifier of an advertisement product as similar to the one embodiment of the present invention, but this identifier is used for the management server 300 to identify which online shopping mall sells the advertisement product having the identifier. To do it, another embodiment of the present invention further includes a shopping mall DB 344 which stores information on the online shopping mall selling advertisement products of interest and the contents for the advertisement products in separate storage locations. The storage locations have identifiers assigned thereto, which correspond to the advertisement products, respectively, in a manner that a storage location is designated by its corresponding identifier. In this embodiment, the information on the shopping mall may be a URL (uniform resource location).

Furthermore, in another embodiment of the present invention, upon receipt of the identifier as a shopping mall access request from the mobile terminal 150, the management server 300 identifies which online shopping mall sells the advertisement product having the identifier, and forwards the shopping mall access request of the mobile terminal to the recognized shopping mall, thereby establishing a connection between the mobile terminal 150 and the shopping mall 350.

FIG. 5 illustrates a flow chart for explaining a content relay operation performed in accordance with one embodiment of the present invention.

In step 502, the display device 100 presents the advertisement products while representing identifiers of the respective display devices and the respective advertisement products as well. If a user of the mobile terminal 150 has an interest in any one of the advertisement products, the user can make a relay request of the content for the advertisement product. If the identifier is the letter (or code), in step 504, the mobile terminal 150 performs a wireless connection by using a WAP browser, and requests for the relay of the content for advertisement product of interest by inputting the identifier in the address bar on the WAP browser in the mobile terminal 150. The identifier for the content relay request is converted into a preset domain name and then sent to the management server 300 through the network 170.

In step 506, based on the identifier for the content relay request, the management server 300 recognizes the display device corresponding to the identifier or the advertisement product corresponding to the identifier.

Next, in step 508, the management server 300 retrieves the contents stored in the storage location in the contents DB 320 indicated by the identifier.

Meanwhile, if the identifier is a telephone number, the mobile terminal 150 requests for the relay of the content for the advertisement contents of interest by directly dialing the telephone number, in step 510. A call of the telephone number for the content relay request is call-forwarded to the management server 300 via the network 180 and the mobile communication system 260.

Then, in step 512, the management server 300 is informed the call-forwarded telephone number from the mobile communication system 260 and thus recognizes the display device corresponding to the identifier or the advertisement product corresponding to the identifier.

Next, in step 514, the management server 300 retrieves the contents stored in the storage location in the contents DB 320 indicated by the identifier.

The contents retrieved in the steps 508 and 514 are relayed to the mobile terminal 150 through the network 170 or 180 in step 516, and stored in the memory 154 of the mobile terminal 150. In these steps, when the management server 300 receives the identifier of the display device, all of the contents providing in the display device are relayed to the mobile terminal 150 at a time, while when receiving the identifier of the advertisement product, only the content for the advertisement product is relayed to the mobile terminal 150.

In step 518, the management server 300 inquires the mobile terminal 150 if the transmission of the GUI program is required. If the mobile terminal 150 requires the transmission of the GUI program, the management server 300 transmits the GUI program to the mobile terminal 150, and the GUI program is stored in the memory 154 of the mobile terminal 150 in step 520.

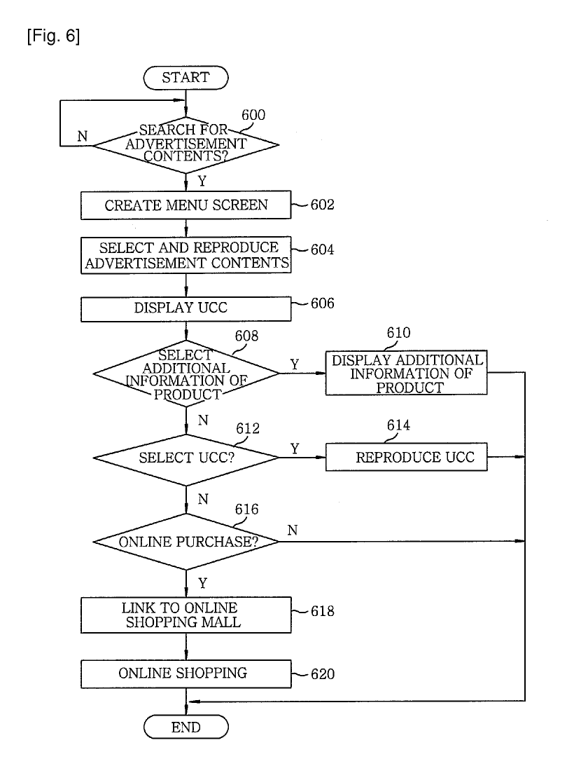

FIG. 6 shows a flow chart for explaining operations of searching for the contents for the advertisement products to choose an advertisement product of interest and performing a purchase of the chosen product in accordance with the embodiment of the present invention.

First, if there is a need to search for the contents for the advertisement products in step 600, the mobile terminal 150 invokes the GUI program stored in the memory 154 and executes the GUI program to create the menu screen on the mobile terminal 150 in step 602.

By selecting any one of a synchronized manner, a slide manner, and a photo review manner as described with reference to FIG. 4, the contents for the advertisement products is reproduced in the center region of the display unit 120 of the mobile terminal 150 in step 604.

Next, in step 606, one or more UCCs corresponding to the contents are arranged in the right side region of the display unit 120 of the mobile terminal 150.

If the product search key 106 is selected in step 608, additional information of the advertisement product is reproduced in the center region of the display unit 120 of the mobile terminal 150 in step 610.

If the UCC search key 104 is selected in step 612, the UCCs corresponding to the advertisement product is reproduced in the center region of the display unit 120 of the mobile terminal 150, thereby enabling the watching of the UCCs in step 614. Regarding the UCC searching, when the content for the advertisement product is relayed to the mobile terminal 150 from the management server 300, a list of the entire UCCs associated with the advertisement product may be relayed. In this case, the mobile terminal 150 may selectively reproduce to watch a specific UCC from the UCC list. Further, when the content for the advertisement product or the UCCs are reproduced in the mobile terminal 150, it is possible to fully display the advertisement product or the related video, photographs, and UCCs on the entire screen of the display unit 316 without creating a number of menu keys on the display unit 316.

Meanwhile, when the shopping mall access key 108 is selected for the online purchase of the advertisement product being currently reproduced in the mobile terminal 150 in step 616, the mobile terminal 150 automatically links to the online shopping mall 350 having a hyperlink via the network 170 or 180 in step 618 so that a shopping procedure required for the online purchase of the product is performed in step 620.

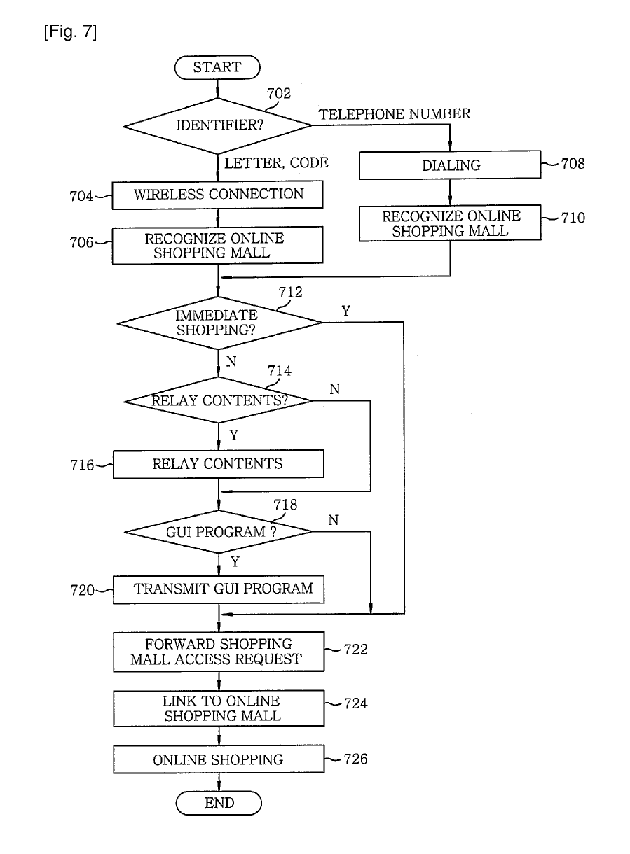

FIG. 7 illustrates a procedure of directly accessing an online shopping mall selling an advertisement product by using an identifier without receiving content for the advertisement product in accordance with another embodiment of the present invention.

In step 702, the display device 100 presents each of the advertisement products while representing an identifier of the advertisement product as well.

In case of an identifier of letter (or code), in step 704, the mobile terminal 150 performs a wireless connection using a WAP browser, and inputs the identifier of an advertisement product of interest in an address bar on the WAP browser in the mobile terminal 150 in order to request a shopping mall access. The identifier for the shopping mall access request is converted into a preset domain name and then sent to the management server 300 through the network 170.

Next, in step 706, by accessing the storage location in the shopping mall DB 344 designated by the identifier to retrieve information on an online shopping mall, the management server 300 recognizes which online shopping mall sells the advertisement product of interest requested by the mobile terminal 150.

Meanwhile, in case of an identifier of a telephone number, in step 708, the telephone number is dialed in the mobile terminal 150, and a call of the telephone number is call-forwarded to the management server 300 via the network 180 and the mobile communication system 260.

Then, in step 710, the management server 300 is informed the call-forwarded telephone number from the mobile communication system 260 and then accesses the storage location in the shopping mall DB 344 designated by the identifier to retrieve information on an online shopping mall, i.e., the URL of the online shopping mall 350. Therefore, the management server 300 recognizes which online shopping mall sells the advertisement product of interest requested by the mobile terminal 150.

Next, in step 712, the management server 300 inquires the mobile terminal 150 about whether or not to immediately proceed with the online shopping of the advertisement product of interest. If the user of the mobile terminal 150 wants to immediately proceed with the online shopping, the process proceeds to step 722. However, if not, the process goes to step 714.

In step 714, the management server 300 inquires the mobile terminal 150 if it wants to receive the content for the advertisement product of interest and the content-related information. If the mobile terminal 150 wants to receive the content for the advertisement product and the content-related information, they are relayed to the mobile terminal 150 and stored in the memory 154 in step 716. However, if not, the process goes to step 718.

In step 718, the management server 300 inquires the mobile terminal 150 if it wants to receive a GUI program for creating a menu screen for reviewing the content and the content-related information. If the mobile terminal 150 wants to receive, the GUI program is transmitted to the mobile terminal 150 and stored in the memory 154 in step 720.

Thereafter, in step 722, the management server 300 forwards the shopping mall access request of the mobile terminal 150 to the recognized shopping mall 350.

Thus, the mobile terminal 150 is linked to the recognized shopping mall 350 in step 724, and the mobile terminal 150 is able to purchase the advertisement product of interest through the linked shopping mall 350 in step 726.

In the steps 716 and 720, after obtaining the content for the advertisement product, the content-related information and the GUI program, the mobile terminal 150 may review the content or the content-related information and then do online shopping of the reviewed product through the procedure as described with reference to FIG. 6, if necessary.

While the invention has been shown and described with respect to the preferred embodiments, it will be understood by those skilled in the art that various changes and modification may be made without departing from the scope of the invention as defined in the following claims.

1. A network-based system for relaying contents for advertisement products, comprising:
a plurality of display devices for advertisement, each of which is configured to present advertisement products and represent identifiers distinguishing each display device and each advertisement product;
one or more mobile terminals for requesting for the relay of a content for an advertisement product of interest or contents including the content for the advertisement product of interest being displayed in any of the display devices via a network by using an identifier; and
a management server for managing information of the identifiers and the contents for the advertisement products, recognizing which display device is presenting the advertisement product of interest or which content is for the advertisement product of interest based on the identifier from the mobile terminal, retrieving the content for the advertisement product of interest or the contents including the content for the advertisement product of interest, and relaying the retrieved content or the retrieved contents to the mobile terminal via the network to thereby interwork with the mobile terminal,
wherein the mobile terminal reproduces and searches for the content or the contents relayed from the management server, and performs electronic commerce of the advertisement product accompanied by the searched content.

2. The system of claim 1, wherein the management server includes a contents database storing a content for each advertisement product and each set of contents including the content for the advertisement product being displayed in each display device in separate storage location, each storage location being designated by a corresponding identifier; and
wherein the management server is informed of the identifier from the mobile terminal via the network and the management server accesses the storage location in the contents database designated by the identifier to retrieve the content and the set of the contents stored in the storage location.

3. The system of claim 2, wherein the network is the Internet, the identifier is a letter or code being inputted in the mobile terminal connected to the network and converted into a preset domain name when requesting the relay of content, the management server has the domain name assigned thereto, and the storage location has a lower directory in the domain name.

4. The system of claim 2, wherein the network is a mobile communication network and the identifier is a telephone number being dialed in the mobile terminal whose call is call-forwarded to the management server when requesting the relay of content, and wherein the storage location has the call-forwarded telephone number assigned thereto.

5. The system of claim 2, wherein the network is a mobile communication network, the management server provides identifiers of one or more display devices located close to the mobile terminal by using location information of the mobile terminal acquired in the network, and the mobile terminal informs the management server of the identifier of the display device which presents the advertisement product of interest among the identifiers of one or more display devices provided from the management server when requesting the relay of content.

6. The system of claim 1, wherein the management server selectively relays a graphic user interface (GUI) program to the mobile terminal, the GUI program creating a menu screen for reproducing and searching for the relayed contents and performing electronic commerce in the mobile terminal.

7. The system of claim 6, wherein the management server further comprises a UCC database for storing UCCs made for each advertisement products, and any of the UCCs in the UCC database is optionally relayed to the mobile terminal in response to a UCC request through the menu screen in the mobile terminal.

8. The system of claim 6, wherein the management server further comprises a product information database for storing product-related information including detailed information of the respective advertisement products and shopping information of the respective advertisement products, and the product-related information in the product information database is optionally relayed to the mobile terminal in response to a request of a product-related information through the menu screen in the mobile terminal.

9. The system of claim 8, wherein the menu screen includes a shopping mall access key to access an online shopping mall selling the advertisement product selected in the menu screen to thereby purchase the advertisement product.

10. The system of claim 1, wherein the subject matter of the respective contents relayed to the mobile terminal is identical to that of the respective advertisement products presented in the display devices, or different from that of presented in the display devices, and wherein the different subject matter have more detailed information edited or added therein.

11. The system of claim 1, wherein the display devices includes electronic signboards for advertisement installed indoors/outdoors of buildings, advertisement monitors, and advertisement panels.

12. A method of searching for advertisement products in a network-based system comprising a plurality of display devices for advertisement, one or more mobile terminal, and a management server, comprising the steps of:
representing an identifier while displaying each of the advertisement products in each of the display devices, each of the display devices and each of the advertisement products being distinguished by the corresponding identifier;
making, at a mobile terminal, a request for the relay of a content for an advertisement product of interest or contents including the content for the advertisement product of interest being displayed in any of the display devices by using the represented identifier via a network;
recognizing, at the management server, which display device is presenting the advertisement product of interest or which content is for the advertisement product of interest based on the identifier from the mobile terminal;
relaying, at the management server, the contents for the advertisement products presented in the recognized display device or the recognized content for the advertisement product of interest and product-related information to the mobile terminal via the network;
providing, at the management server, the mobile terminal with a graphic user interface (GUI) program for creating a menu screen for searching for the contents and the product-related information; and
searching for, at the mobile terminal, an advertisement product accompanied by the contents and the product-related information through the menu screen created by the GUI program.

13. The method of claim 12, wherein the step of making the relay request of content includes:
accessing the network;
inputting the identifier in an address bar in the mobile terminal connected to the network to inform the management server of the identifier,
wherein the management server includes a contents database storing a content for each advertisement product and each set of contents including the content for the advertisement product of interest being displayed in each display device in separate storage locations, each storage location being designated by a corresponding identifier;
wherein the network is the Internet, and the identifier inputted in the address bar is a letter or code and is converted into a domain name in the network;
wherein the management server has the domain name assigned thereto and the storage location has a lower directory in the domain name assigned thereto; and
wherein the management server retrieves the content and the set of the contents stored in the storage location in the contents database designated by the lower directory.

14. The method of claim 12, wherein the step of making the relay request of content includes the step of:
dialing the identifier in the mobile terminal to inform the management server of the identifier when requesting the relay of content,
wherein the management server includes a contents database storing a content for each advertisement product and each set of contents including the content for the advertisement product being displayed in each display device in separate storage locations, each storage location being designated by a corresponding identifier;
wherein the network is a mobile communication network, and the identifier is a telephone number whose call is call-forwarded to the management server via the network; and
wherein the storage location has the call-forwarded telephone number assigned thereto and the management server retrieves the content and the set of the contents stored in the storage location in the contents database designated by the call-forwarded telephone number.

15. The method of claim 12, wherein the step of making the relay request of content includes the steps of:
obtaining position information of the mobile terminal at the network, wherein the network is a mobile communication network;
transmitting identifiers of one or more display devices located closed to the mobile terminal from the management server to the mobile terminal based on the position information of the mobile terminal; and
selecting, at the mobile terminal, the identifier of the display device which presents the advertisement product of interest among the identifiers of one or more display devices transmitted from the management server to inform the management server of the selected identifier,
wherein the management server includes a contents database storing each set of contents including the content for the advertisement product of interest being displayed in each display device in separate storage locations, each storage location being designated by a corresponding identifier; and
wherein the management server retrieving the contents stored in the storage location in the contents database designated by the selected identifier.

16. The method of claim 12, wherein the product-related information includes one or more UCCs made for each advertisement product, detailed information of each advertisement product, and shopping information of each advertisement product.

17. The method of claim 16, further comprising the step of selectively providing a graphic user interface (GUI) program when relaying the contents to the mobile terminal,
wherein the GUI program creates a menu screen used to reproduce and search for the product-related information, and perform to purchase an advertisement product accompanied by the product-related information.

18. The method of claim 17, wherein the menu screen includes a shopping mall access key for the purchase of the advertisement product, and
wherein the method further comprises the step of performing a purchase of the advertisement product by accessing an online shopping mall selling the advertisement product using the shopping mall access key.

19. The method of claim 18, wherein the step of performing the purchase of the advertisement product includes the step of purchasing the advertisement product by collaboration between one or more terminals having an interest in the same advertisement product.

20. The method of claim 18, wherein the step of performing a purchase of the advertisement product includes the step of purchasing the advertisement product by reverse auction between one or more terminals having an interest in the same advertisement product.

21. The method of claim 12, wherein the subject matter of the contents relayed to the mobile terminal is identical to that of the respective advertisement products presented in the display device, or different from that of presented in the display device, and wherein the different subject matter have more detailed information edited or added therein.

22. A method of performing electronic commerce of advertisement products in a network-based system including a plurality of display devices for advertisement, one or more mobile terminals, a management server and online shopping malls, comprising the steps of:
displaying each of the advertisement products in the display devices while representing an identifier thereof, each of the advertisement products being distinguished by the corresponding identifier;
making, at the mobile terminal, a request for access to an online shopping mall selling anyone of interest among the advertisement products via a network by using the represented identifier;
recognizing, at the management server, the online shopping mall selling the product of interest based on the represented identifier transmitted from the mobile terminal and forwarding the shopping mall access request of the mobile terminal to the recognized online shopping mall so as to establish a link between the mobile terminal and the recognized online shopping mall; and
performing, at the mobile terminal, a purchase of the product of interest from the linked online shopping mall.

23. The method of claim 22, further comprising the steps:
selectively providing the mobile terminal with the content for the advertisement product and information on the advertisement product upon requesting from the mobile terminal;
selectively providing a graphic user interface (GUI) program to the mobile terminal from the management server upon requesting from the mobile terminal;
creating a menu screen to display the content for the advertisement product on the mobile terminal by driving the GUI program, reviewing the content for the advertisement product and the information thereof through the menu screen; and
performing a purchase of the advertisement product.

24. The method of claim 23, wherein the information on the advertisement product includes one or more UCCs related to the advertisement product, detailed information of the advertisement product, shopping information of the advertisement product and discount information of the advertisement product.

25. The method of claim 23, wherein the menu screen includes a shopping mall access key for the purchase of the advertisement product, and
wherein the step of performing the purchase of the advertisement product further comprises accessing an online shopping mall selling the advertisement product by using the shopping mall access key to purchase the advertisement product.

26. The method of claim 23, wherein the step of performing the purchase of the advertisement product includes the step of purchasing the advertisement product by collaboration between one or more terminals having an interest in the same advertisement product.

27. The method of claim 23, wherein the step of performing the purchase of the reviewed product includes the step of purchasing the advertisement product by reverse auction between one or more terminals having an interest in the same advertisement product.
